(19) United States
(12) Patent Application Publication
(10) Pub. No.: US 2026/0025415 A1
(43) Pub. Date: Jan. 22, 2026

(54) EMERGENCY MULTIMEDIA SESSION SUPPORT IN WIRELESS COMMUNICATION NETWORKS

(71) Applicant: T-MOBILE INNOVATIONS LLC, Overland Park, KS (US)

(72) Inventors: Harikishore Allu Balan, Lynnwood, WA (US); Jagannadha Anudeep Varma Datla, Kent, WA (US)

(21) Appl. No.: 18/778,491

(22) Filed: Jul. 19, 2024

(51) Int. Cl. H04L 65/1016; H04L 65/1069; H04L 65/1096; H04W 4/029; H04W 4/90

(52) U.S. Cl. CPC H04L 65/1016; H04L 65/1069; H04L 65/1096; H04W 4/029; H04W 4/90

(57) ABSTRACT

Various embodiments comprise a communication network comprising a multimedia controller. The multimedia controller receives an emergency contact list from a user device that identifies another user device. The multimedia controller transfers an emergency contact request to the other user device and receives an accept response from the other user device. The multimedia controller creates a contact binding that pre-approves multimedia sessions between the user device and the other user device and that indicates a network location of the other user device. The multimedia controller receives an emergency call request from the user device to establish an emergency multimedia session with the other user device and forwards the request to the other user device. The multimedia controller establishes a one-way multimedia session between the user device and the other user device. The multimedia controller establishes a two-way multimedia session in response to the other user device accepting the emergency call request.

### TECHNICAL FIELD

Various embodiments of the present technology relate to multimedia systems, and more specifically, to supporting emergency multimedia sessions between user devices.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Internet Protocol Multimedia Subsystem (IMS) supports Internet Protocol (IP) multimedia services like voice calling and video conferencing between wireless user devices. The IMS distributes IP addresses to the wireless user devices to facilitate communications between the wireless user devices. The IMS interfaces with wireless network cores to exchange Session Initiation Protocol (SIP) messages with the wireless user devices to communicate with the wireless user devices. The IMS comprises network functions and network elements like Call Session Control Function (CSCF), Border Gateway (BGW), and Telephony Application Server (TAS).

When an originating (i.e., calling) wireless user device begins an IMS voice session with a terminating (i.e., called) user device, the originating user device transfers an invite message to the IMS. The IMS routes the invite message to the terminating user device. If the terminating user device accepts the call, the IMS organizes the end-to-end connection between the calling and called user devices. To organize the end-to-end connection, IMS functions interface with each other to locate the called device and reserve network and radio resources to support the call. Once the connection is set up, the called and calling devices undergo a signaling intensive handshake process to request, accept the call, and begin exchanging voice data.

The IMS function interfacing and signaling intensive handshake process increase the time it takes to create the voice call. The increased time negatively affects the user experience during emergency situations. Unfortunately, in some instances, wireless communication networks may not always effectively or efficiently create multimedia sessions like voice calls during emergency situations.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for multimedia sessions. Some embodiments comprise a method. The method comprises, receiving, by a multimedia controller in a communication network, an emergency contact list from the user device that identifies another user device. The method further comprises transferring, by the multimedia controller, an emergency contact request to the other user device and receiving an emergency contact accept response from the other user device. The method further comprises creating, by the multimedia controller, a contact binding that pre-approves multimedia sessions between the user device and the other user device and that indicates a network location of the other user device. The method further comprises receiving, by the multimedia controller, an emergency call request from the user device to establish an emergency multimedia session with the other user device. The method further comprises forwarding, by the multimedia controller, the emergency call request to the other user device based on the network location of the other user device. The method further comprises establishing, by the multimedia controller, a one-way multimedia session between the user device and the other user device based on the multimedia session pre-approval. The method further comprises establishing, by the multimedia controller, a two-way multimedia session based on the multimedia session pre-approval in response to the other user device accepting the emergency call request.

Some embodiments comprise a communication network. The communication network comprises a multimedia controller. Responsive to multimedia service registration for a user device, the multimedia controller receives an emergency contact list from the user device that identifies another user device. The multimedia controller transfers an emergency contact request to the other user device and receives an emergency contact accept response from the other user device. The other user device receives the emergency contact request, approves the request, and transfers the emergency contact accept response for delivery to the multimedia controller. The multimedia controller creates a contact binding that pre-approves multimedia sessions between the user device and the other user device and that indicates a network location of the other user device. The multimedia controller receives an emergency call request from the user device to establish an emergency multimedia session with the other user device. The multimedia controller forwards the emergency call request to the other user device based on the network location of the other user device. The multimedia controller establishes a one-way multimedia session between the user device and the other user device based on the multimedia session pre-approval. The multimedia controller establishes a two-way multimedia session in response to the other user device accepting the emergency call request based on the multimedia session pre-approval.

Some embodiments comprise one or more non-transitory computer-readable storage media having program instructions stored thereon. The program instructions, when executed by a computing system, direct the computing system to perform operations. The operations comprise creating a contact binding that pre-approves emergency multimedia sessions between a user device and another user device and that indicates a location of the other user device. The operations further comprise receiving an emergency call invite from the user device to establish an emergency multimedia session with the other user device. The operations further comprise forwarding the emergency call invite to the other user device based on the contact binding. The operations further comprise delivering a push-to-talk voice message from the user device to the other user device based on the contact binding. The operations further comprise establishing a voice call between the user device and the other user device in response to the other user device accepting the emergency call invite.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates a first exemplary operation of the communication network.

FIG. 3 illustrates a second exemplary operation of the communication network.

FIG. 4 illustrates a third exemplary operation of the communication network.

FIG. 5 illustrates a Fifth Generation (5G) communication network.

FIG. 6 illustrates a wireless User Equipment (UE) in the 5G communication network.

FIG. 7 illustrates a Radio Access Network (RAN) in the 5G communication network.

FIG. 8 illustrates a Network Function Virtualization Infrastructure (NFVI) in the 5G communication network.

FIG. 9 further illustrates the NFVI in the 5G wireless communication network.

FIG. 10 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

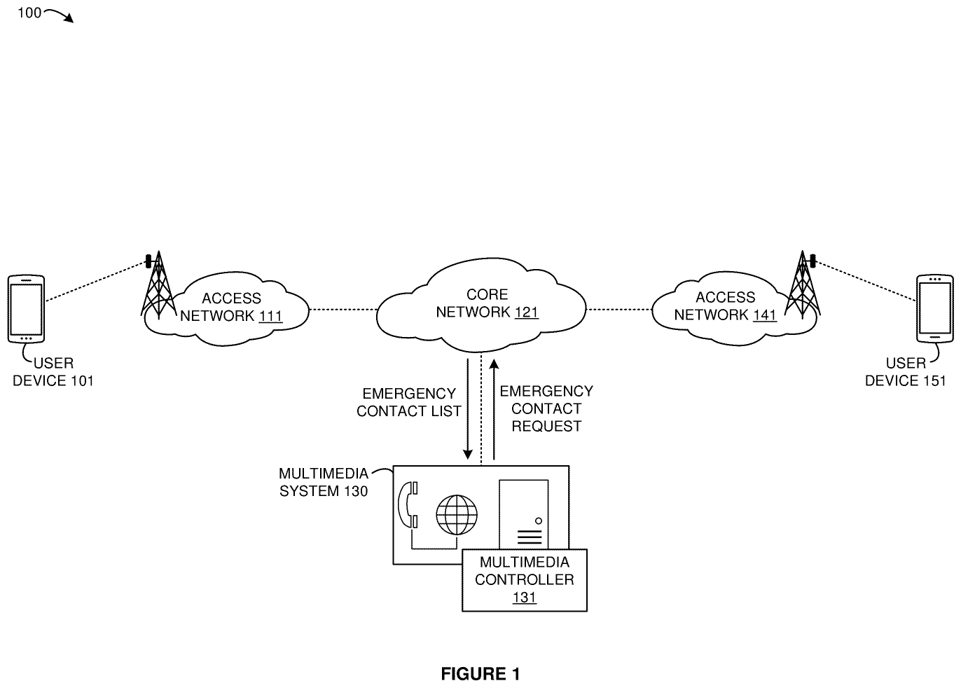

FIG. 1 illustrates communication network 100 network to support emergency multimedia sessions between wireless user devices. Communication network 100 delivers services like voice calling, video calling, text messaging, media-streaming, internet-access, machine communications, or some other wireless communications product to user devices. Communication network 100 comprises user devices 101 and 151, access networks 111 and 141, core network 121, and multimedia system 130. Multimedia system 130 comprises multimedia controller 131. In other examples, communication network 100 may comprise additional or different elements than those illustrated in FIG. 1.

Various examples of network operation and configuration are described herein. In some examples, user device 101 attaches to core network 121 over access network 111 and registers for service with core network 121. Once registered on core network 121, user device 101 registers for multimedia services with multimedia system 130. Exemplary multimedia services include voice/video calling and text messaging. Registration comprises an authentication/authorization process to verify the identity of user device 101 and to determine which services user device 101 is subscribed to. Multimedia controller 131 registers user device 101 and indicates the successful registration to user device 101 over core network 121 and access network 111. Responsive to successful multimedia registration, multimedia controller 131 receives an emergency contact list from user device 101 with permission from the user of user device 101. For example, the multimedia controller 131 may receive the emergency contact list after the user provided an authorization input to the user device 101 or another device of the user that authorizes the sharing of the emergency contact list. The contact list identifies user device 151 as belonging to a second user that is the emergency contact of a user of user device 101. Multimedia controller 131, with authorization from the user of the user device 101, transfers an emergency contact request to user device 151 over core network 121 and access network 141. For example, the user may input the authorization at the user device 101 or another device of the user. User device 151 receives and accepts, based on an input from the second user at the user device 151 or another device of the second user, the request and responsively transfers an emergency contact response indicating the acceptance for delivery to multimedia controller 131. Multimedia controller 131 receives the response and creates a contact binding between user devices 101 and 151. The contact binding pre-approves multimedia sessions from user device 101 to user device 151 (e.g., emergency or otherwise urgent voice sessions from user device 101 to user device 151) and indicates the network location of user device 151 (e.g., which portion of multimedia system 130 user device 151 is registered with).

Subsequent to the creation of the contact binding, user device 101 initiates an emergency multimedia session with user device 151. For example, user device 101 may initiate the emergency multimedia session based on a user initiation input to the user device, such as the placement of an emergency call at the user device 101. User device 101 transfers an emergency multimedia session request for an emergency multimedia session with user device 151 for delivery to multimedia controller 131. Multimedia controller 131 accesses the contact binding to confirm user device 151 is an authorized emergency contact of user device 101. Multimedia controller 131 forwards the emergency multimedia session request to user device 151 based on the network location of user device 151 included in the contact binding. Multimedia controller 131 establishes a one-way multimedia session from user device 101 to user device 151 based on the multimedia session pre-approval included in the contact binding. The one-way multimedia session traverses access networks 111 and 141, core network 121, and multimedia system 130. The one-way multimedia session allows user device 101 to transfer communications (e.g., push-to-talk calls, voice messages, etc.) to user device 151 before user device 151 has accepted the emergency multimedia session request.

After (or contemporaneously) the one-way multimedia session is set up, user device 151 receives and accepts the emergency multimedia session request. For example, the user device 151 may accept the session request based on a user acceptance input to the user device 151 or another device of the second user. User device 151 transfers an emergency multimedia session response indicating the acceptance to user device 101 over access networks 111 and 141, core network 121, and multimedia system 130. Multimedia controller 131 detects the acceptance and establishes a two-way multimedia session (e.g., a voice call) between user device 101 and user device 151 based on the multimedia session pre-approval included in the contact binding. Multimedia controller 131 establishes the two-way multimedia session without having user devices 101 and 151 to undergo the normal handshake process to establish two-way multimedia sessions like voice calls which reduces the time required to create the two-way multimedia session. The two-way multimedia session traverses access networks 111 and 141, core network 121, and multimedia system 130. The two-way multimedia session allows user device 101 and user device 151 to exchange communications (e.g., a voice call) after user device 151 has accepted the emergency multimedia session request. For example, the two-way multimedia session may comprise a voice call, a Voice Over Long Term Evolution (VOLTE) call, a Voice over New Radio (VoNR) call, or some other type of multimedia session between user devices 101 and 151.

Advantageously, communication network 100 effectively and efficiently creates multimedia sessions like voice calls during emergency situations. Moreover, communication network 100 reduces the signaling load during voice call setup to decrease the amount of time required to create a voice call. This decrease in time improves the user experience by expediting the creation of multimedia sessions between devices during emergency situations.

User devices 101 and 151 comprise phones, computers, vehicles, drones, robots, sensors, or other types of data appliance with wireless and/or wireline communication circuitry. User devices 101 and 151 and access networks 111 and 141 communicate over links using wireless and/or wireline technologies like Sixth Generation Radio (6GR), Fifth Generation New Radio (5GNR), Long Term Evolution (LTE), Institute of Electrical and Electronic Engineers (IEEE) 802.11 (WiFi), Low-Power Wide Area Network (LP-WAN), Bluetooth, IEEE 802.3 (Ethernet), and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access networks 111 and 141 are illustrated as towers, access networks 111 and 141 may comprise other types of mounting structures (e.g., buildings), or no mounting structures at all. Access networks 111 and 141 comprise Sixth Generation (6G) Radio Access Networks (RANs), Fifth Generation (5G) RANs, LTE RANs, gNodeBs, eNodeBs, Narrow Band Internet-of-Things (NB-IoT) access nodes, trusted non-Third Generation Partnership Project (3GPP) access nodes, untrusted non-3GPP access nodes, LP-WAN base stations, wireless relays, WIFI hotspots, Bluetooth access nodes, Ethernet access nodes, and/or another wireless or wireline network transceiver. Access networks 111 and 141 exchange network signaling and user data with network functions clustered together into core network 121. Access networks 111 and 141 are connected to core network 121 over backhaul data links. Access networks 111 and 141 and core network 121 may communicate via edge networks like internet backbone providers, edge computing systems, or other types of edge systems to provide the backhaul data links between access networks 111 and 141 and core network 121.

Access networks 111 and 141 may comprise Radio Units (RUS), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 121. Access networks 111 and 141 may comprise Baseband Units (BBUs). The BBUs handle lower and higher network layers like RRC, PDCP, RLC, MAC, and PHY. The BBUs are coupled to network entities in core network 121.

Core network 121 is representative of computing systems that provide wireless/wireline data services to user devices 101 and 151 over access networks 111 and 141. Exemplary computing systems comprise Network Function Virtualization Infrastructure (NFVI) systems, data centers, server farms, cloud computing networks, hybrid cloud networks, and the like. Core network 121 may comprise a 3GPP core network architecture like Sixth Generation Core (6GC), Fifth Generation Core (5GC), Evolved Packet Core (EPC), and/or another type of 3GPP core network architecture. Access networks 111 and 141, core network 121, and multimedia system 130 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WIFI, virtual switching, inter-processor communication, bus interfaces, and/or some other data communication protocols. The computing systems of core network 121 store and execute the network functions/entities to serve user devices 101 and 151 over access networks 111 and 141. Exemplary network functions and network entities include Access and Mobility Management Function (AMF), Session Management Function (SMF), User Plane Function (UPF), Policy Control Function (PCF), Unified Data Management (UDM), Mobility Management Entity (MME), Serving Gateway (S-GW), Packet Gateway (P-GW), Policy and Rules Charging Function (PCRF), Home Subscriber Server (HSS), and the like.

The computing systems of multimedia system 130 store and execute multimedia controller 131 to provide multimedia services like voice calling, video conferencing, and text messaging to user devices 101 and 151 over core network 121 and access networks 111 and 141. For example, multimedia system 130 may receive text messages and voice call requests sent by user device 101 and route the text messages and voice call requests to their respective message destinations. Multimedia controller 131 may comprise one or more multimedia functions like Proxy-Call Session Control Function (P-CSCF), Interrogating-Call Session Control Function (I-CSCF), Serving-Call Session Control Function (S-CSCF), Telephony Application Server (TAS), Border Gateway (BGW), Short Message Service Application Server (SMS AS), Rich Communication Service Application Server (RCS AS), and the like. Multimedia system 130 may comprise an Internet Protocol Multimedia Subsystem (IMS) core architecture.

User devices 101 and 151 and access networks 111 and 141 comprise antennas, amplifiers, filters, modulation, analog/digital interfaces, microprocessors, software, memories, transceivers, bus circuitry, and the like. User devices 101 and 151, access networks 111 and 141, core network 121, and multimedia system 130 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 100 as described herein.

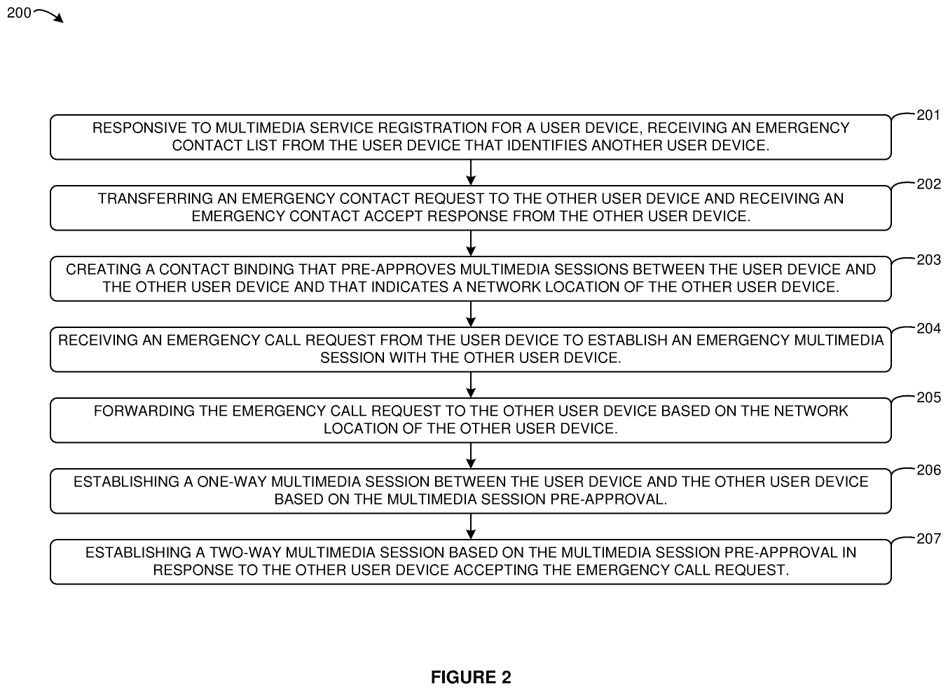

FIG. 2 illustrates process 200. Process 200 comprises an exemplary operation of communication network 100 to support emergency multimedia sessions between user devices. The operation may vary in other examples. The operations of process 200 comprise responsive to multimedia service registration for a user device, receiving an emergency contact list from the user device that identifies another user device (step 201). The operations further comprise transferring an emergency contact request to the other user device and receiving an emergency contact accept response from the other user device (step 202). The operations further comprise creating a contact binding that pre-approves multimedia sessions between the user device and the other user device and that indicates a network location of the other user device (step 203). The operations further comprise receiving an emergency call request from the other user device to establish an emergency multimedia session with the other user device (step 204). The operations further comprise forwarding the emergency call request to the other user device based on the network location of the other user device (step 205). The operations further comprise establishing a one-way multimedia session between the user device and the other user device based on the multimedia session pre-approval (step 206). The operations further comprise establishing a two-way multimedia session based on the multimedia session pre-approval in response to the other user device accepting the emergency call request (step 207).

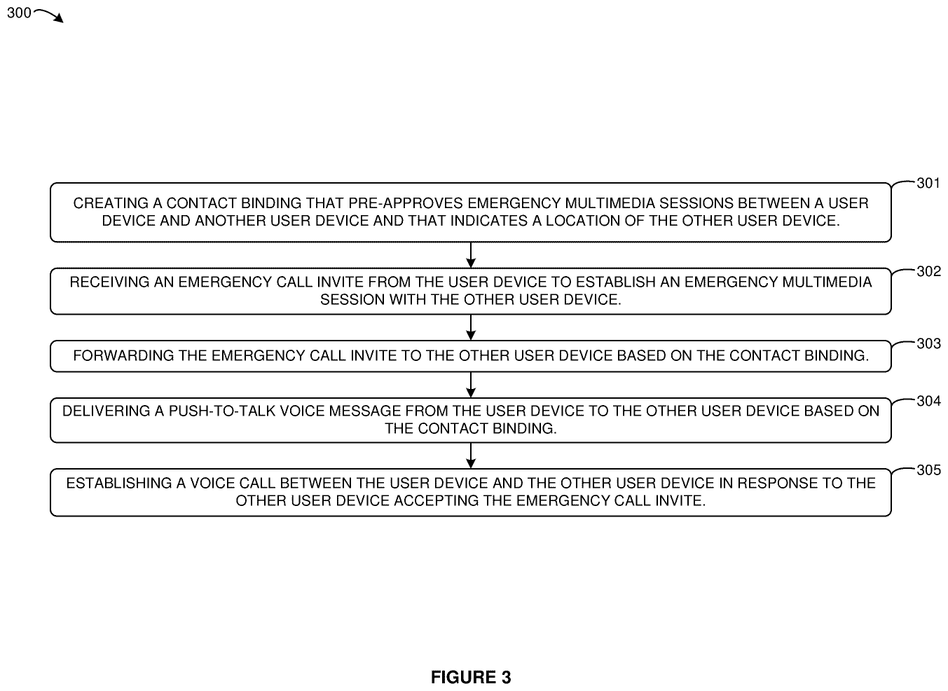

FIG. 3 illustrates process 300. Process 300 comprises an exemplary operation of communication network 100 to support emergency multimedia sessions between user devices. The operation may vary in other examples. Process 300 comprises an example of process 200 illustrated in FIG. 2, however process 200 may differ. The operations of process 300 comprise creating a contact binding that pre-approves emergency multimedia sessions between a user device and another user device and that indicates a location of the other user device (step 301). The operations further comprise receiving an emergency call invite from the user device to establish an emergency multimedia session with the other user device (step 302). The operations further comprise forwarding the emergency call invite to the other user device based on the contact binding (step 303). The operations further comprise delivering a push-to-talk voice message from the user device to the other user device based on the contact binding (step 304). The operations further comprise establishing a voice call between the user device and the other user device in response to the other user device accepting the emergency call invite (step 305).

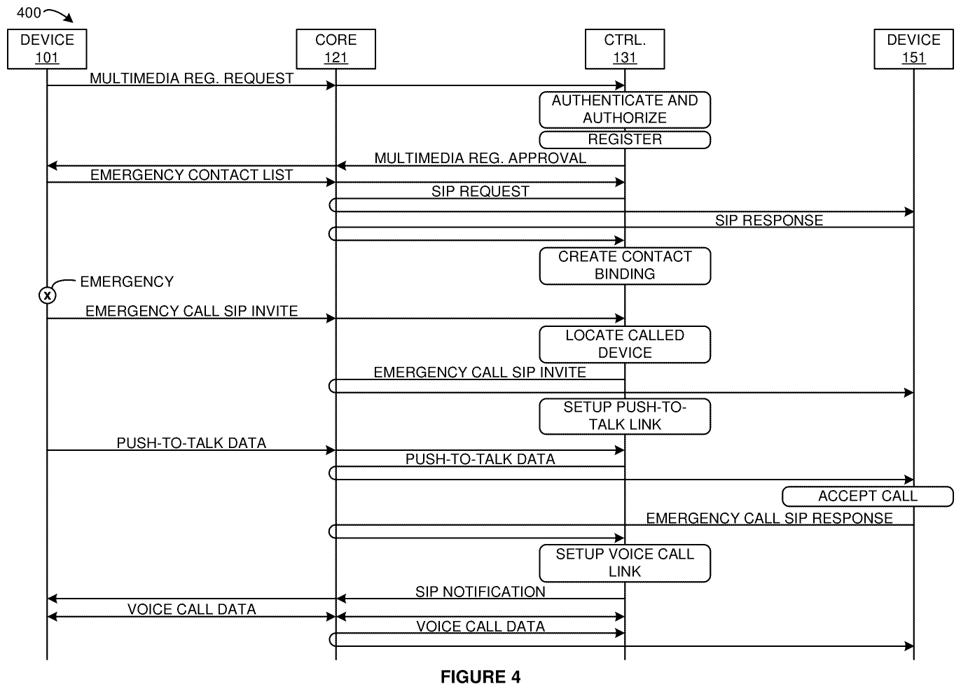

FIG. 4 illustrates process 400. Process 400 comprises an exemplary operation of communication network 100 to support emergency multimedia sessions between wireless user devices. Process 400 comprises an example of processes 200 and 300 illustrated in FIGS. 2 and 3, however processes 200 and 300 may differ. The operation may vary in other examples. In some examples, user device 101 attaches to access network 111. User device 101 and access network 111 implement a Random Access Channel (RACH) process to establish a signaling link between user device 101 and access network 111. Once the signaling link is established, user device 101 transfers a registration request to core network 121 over access network 111 via the signaling link. Core network 121 authenticates the identity of user device 101 and authorizes user device 101 for service on communication network 100 based on the registration request. For example, core network 121 may access a subscriber profile for user device 101 to authenticate and authorize user device 101 for service on core network 121. In response to authentication and authorization, core network 121 establishes a data link with user device 101 over access network 111 and registers user device 101 for service on core network 121. Core network 121 transfers a registration approval message to user device 101 over access network 111.

In response to core network registration, user device 101 transfers a multimedia registration (REG.) request to multimedia system 130 over access network 111 and core network 121. For example, when multimedia system 130 comprises an IMS, user device 101 may transfer a Session Initiation Protocol (SIP) message that encapsulates an IMS registration request to multimedia system 130. Multimedia controller (CTRL.) 131 receives the request and registers device for multimedia services like voice calling, video calling, SMS message, RCS messaging, and the like. Multimedia system 130 transfers a registration approval message to user device 101 over core network 121 and access network 111.

Once registered with multimedia system 130, user device 101 receives a user input selecting user device 151 as an emergency contact. In response to the user input, user device 101 transfers an emergency contact list to multimedia controller 131 over access network 111 and core network 121. For example, the emergency contact list may identify user device 101 by a subscriber Identifier (ID) like Subscriber Concealed Identifier (SUCI), Subscriber Permanent Identifier (SUPI), International Mobile Subscriber Identity (IMSI), and the like. Multimedia controller 131 retrieves the network location of user device 151 from core network 121. Multimedia controller 131 transfers a SIP request for emergency contact authorization to user device 151 over core network 121 and access network 141 based on the network location of user device 151. User device 151 receives the SIP request and displays an emergency contact authorization request. User device 151 receives a user input accepting the authorization and transfers a SIP response authorizing user device 151 to be made an emergency contact for user device 101. Multimedia controller 131 receives the SIP response and creates a contact binding between user device 101 and user device 151. The contact binding identifies user device 151 as an emergency contact for user device 101 (e.g., by subscriber ID), pre-approves emergency multimedia sessions from user device 101 to user device 151, and indicates the network location of user device 151. Multimedia controller 131 interfaces with core network 121 to maintain an up-to-date network location of user device 151 in the contact binding. For example, multimedia controller 131 may periodically (e.g., every 15 minutes) ping core network 121 to determine the network location of user device 151. When the network location of user device 151 changes, multimedia controller 131 detects the location change and updates the contact binding accordingly. Multimedia controller 131 notifies user device 101 of the successful emergency contact creation for user device 151.

Subsequent to the creation of the contact binding, an emergency occurs affecting the user of the user device 101. Accordingly, the user may initiate an emergency call at user device 101. In response, user device 101 transfers an emergency call SIP invite for delivery to user device 151. Multimedia controller 131 receives the SIP invite and accesses the contact binding associated with user device 101 to authorize the emergency call with user device 151 and determine the network location of user device 151 (i.e., the called device). For example, the SIP invite may comprise a message header that identifies the invite as an emergency call between two user devices. This message header may trigger multimedia controller 131 to access the contact binding to approve the emergency multimedia session. Multimedia controller 131 determines user device 151 is a valid emergency contact of user device 101 and determines the network location of user device 151 based on the contact binding. In response, multimedia controller 131 forwards the emergency call SIP invite to user device 151 over core network 121 and access network 141.

Since emergency multimedia sessions are pre-approved from user device 101 to user device 151, multimedia controller 131 establishes a push-to-talk link from user device 101 to user device 151 prior to user device 151 accepting the emergency call SIP invite and/or establishment of a two-way voice call between user devices 101 and 151. Multimedia controller 131 notifies user device 101 that the push-to-talk link is ready (e.g., by audio queue). The push-to-talk link allows user device 101 to send voice communications to user device 151 without user device 151 having to accept the call but does not support two-way voice communications between user devices 101 and 151. User device 101 transfers push-to-talk data to multimedia controller 131 over access network 111 and core network 121. Multimedia controller 131 routes the push-to-talk data to user device 151 over core network 121 and access network 141.

Subsequently, user device 151 receives and accepts the emergency call SIP invite and transfers and emergency call SIP response indicating the acceptance to multimedia controller 131. Multimedia controller 131 transfers a SIP notification to user device 101 to indicate the call acceptance. Multimedia controller 131 establishes a voice call link between user device 101 and user device 151 without having user devices 101 and 151 to undergo a handshake process based on the emergency multimedia session pre-approval included in the contact binding. The voice call link allows user devices 101 and 151 to exchange two-way voice communication. For example, the voice call link may support a Voice over New Radio (VoNR) session, a Voice over Long Term Evolution (VOLTE) session, or some other type of voice call technology type session. Multimedia controller 131 transfers a SIP notification to user device 101 indicating the voice call link is ready. User device 101 exchanges voice call data with multimedia controller 131 over access network 111 and core network 121. Multimedia controller 131 exchanges the voice call data with user device 151 over core network 121 and access network 141.

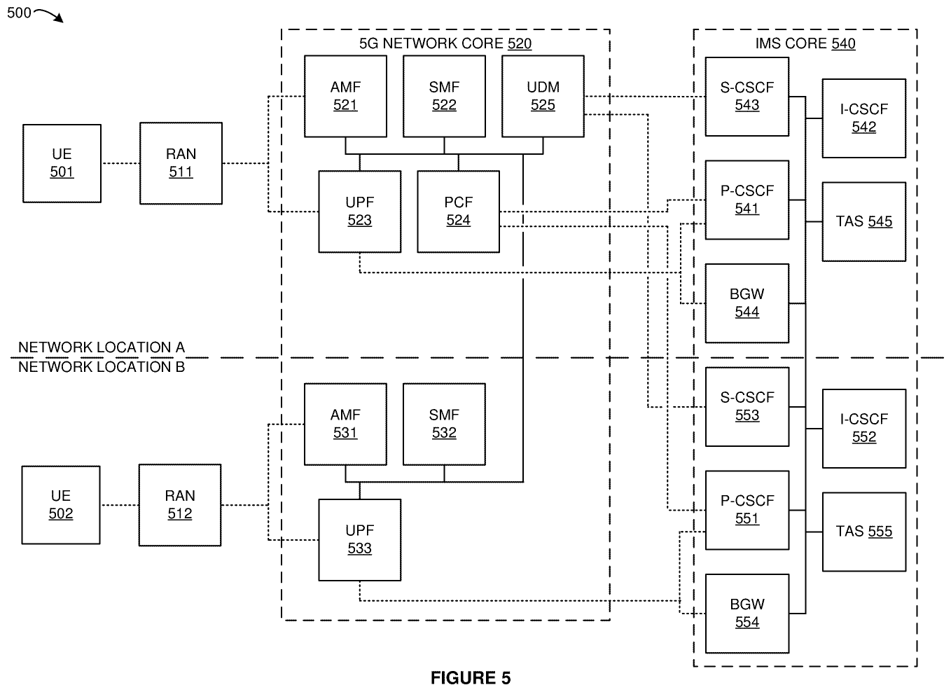

FIG. 5 illustrates 5G communication network 500 to support emergency IMS sessions between wireless User Equipment (UEs). 5G communication network 500 comprises an example of communication network 100 illustrated in FIG. 1, however communication network 100 may differ. 5G communication network 500 comprises UE 501, UE 502, RAN 511, RAN 512, 5G network core 520, and IMS core 540. 5G network core 520 comprises AMF 521, SMF 522, UPF 523, PCF 524, UDM 525, AMF 531, SMF 532, and UPF 533. Other network functions and network entities like Authenticating Server Function (AUSF), Network Slice Selection Function (NSSF), Unified Data Registry (UDR), Home Subscriber Register (HLR), Home Subscriber Server (HSS), Network Repository Function (NRF), Short Message Service Function (SMSF), Network Exposure Function (NEF), Application Function (AF), Equipment Identity Register (EIR), and Session Communication Proxy (SCP) are typically present in 5G network core 520 but are omitted for clarity. IMS core 540 comprises P-CSCF 541, I-CSCF 542, S-CSCF 543, BGW 544, TAS 545, P-CSCF 551, I-CSCF 552, S-CSCF 553, BGW 554, and TAS 555. Other network functions and network entities like, Interconnect Session Border Controller (ISBC), SMS AS, and RCS AS are typically present in IMS core 540 but are omitted for clarity. In other examples, 5G communication network 500 may comprise different or additional elements than those illustrated in FIG. 5. 5G communication network 500 comprises network location A and network location B. Locations A and B may correspond to geographically disparate or geographically proximate locations. As illustrated in FIG. 5, UE 501, RAN 511, network functions 521-525, and IMS functions 541-545 reside in network location A while UE 502, RAN 512, network functions 531-533, and IMS functions 551-555 reside in network location B. While illustrated as comprising 5G capabilities, 5G network core 520 typically comprises LTE capabilities as well. 5G network core 520 may store and execute EPC network entities like MME, S-GW, P-GW, PCRF, HLR, and HSS, however the EPC network entities are omitted for clarity.

In some examples, UE 501 wirelessly attaches to RAN 511 over a 5GNR link. UE 501 may also (or instead) attach to RAN 511 over an LTE link or other type of wireless networking protocol supported by RAN 511. UE 501 undergoes a RACH procedure with RAN 511 to establish a secure signaling channel. UE 501 transfers a registration request to AMF 521 over RAN 511. The registration request indicates a registration type, 5G-Global Unique Temporary Identifier (GUTI), Tracking Area Identifier (TAI), Network Slice Selection Assistance Information (NSSAI) requests, UE capabilities, Protocol Data Unit (PDU) session requests, and the like. In response to the registration request, AMF 521 transfers a Non-Access Stratum (NAS) identity request to UE 501 over a NAS signaling link between UE 501 and AMF 521 that traverses RAN 511. UE 501 indicates its Subscriber Concealed Identifier (SUCI) to AMF 521 over the NAS link that traverses RAN 511. AMF 521 indicates the SUCI of UE 501 to UDM 525, typically over an AUSF, to retrieve authentication vectors to authenticate UE 501. UDM 525 converts the SUCI for UE 501 into a Subscriber Permanent Identifier (SUPI) for UE 501. UDM 525 returns the SUPI and authentication vectors like an expected result, random number, key selection criteria, and the like to AMF 521. AMF 521 transfers an authentication challenge that comprises the random number and key selection criteria to UE 501 over the NAS link that traverses RAN 511. UE 501 hashes random number with its secret key to generate an authentication result and indicates the authentication result to AMF 521 over the NAS link. AMF 521 matches the expected result retrieved from UDM 525 with the authentication result received from UE 501 to authenticate UE 501.

Responsive to the authentication, AMF 521 transfers a context registration request to UDM 525 that includes an AMF ID, a supported feature list, a Permanent Equipment Identifier (PEI) for UE 501, and the like. UDM 525 indicates successful UDM registration to AMF 521. In response, AMF 521 requests access and mobility subscription data, SMS selection subscription data, and UE context in SMF data from UDM 525. UDM 525 accesses the subscriber profile for UE 501 (typically stored on a UDR) and returns the requested data. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of S-NSSAIs and associated information. The UE context in SMF data comprises PDU session and EPC interworking information. AMF 521 forms the UE context for UE 501 using the retrieved information. The UE context defines the authorized services for UE 501.

AMF 521 transfers a policy creation request to PCF 524 to create a policy association for UE 501. PCF 524 responds to the request with policy association information like the SUPI, GPSI, PEI, and user location information for UE 501. PCF 524 subscribes to AMF 521 for event reporting like user location updates, registration state changes, communication failure events, and the like. AMF 521 creates a PCF subscription based on the policy association information and signals to PCF 524 of the successful subscription creation. AMF 521 may also select one or more network slices for UE 501 based on the slice selection information. For example, AMF 521 may interface with an NSSF to translate requested/allowed NSSAIs for UE 501 into network slice instances in 5G network core 520.

Responsive to policy association creation, AMF 521 selects SMF 522 to serve UE 501 based on the SMF selection data received from UDM 525 and the network policies received from PCF 524. AMF 521 transfers a PDU session list (as received during the registration request) and PDU session activation command to SMF 522. SMF 522 allocates UE IP addresses for the requested PDU sessions, allocates Tunnel End Point ID (TEID) for the PDU session, and selects UPF 523 to support the PDU sessions. Upon selection of UPF 523, SMF 522 transfers a session modification request that includes a session endpoint identifier and TEID to UPF 523 to setup the default bearer for UE 501. The default bearer is a link to carry data and voice/IP message packets for UE 501 over RAN 511 and UPF 523. For example, the default bearer may be used to support a VoNR call between UE 501 and UE 502.

SMF 522 notifies AMF 521 that the default bearer is set up as well as a network address for P-CSCF 541 for UE 501 to perform IMS registration. AMF 521 successfully registers UE 501 for service on network 500. AMF 521 generates a registration accept message that includes the UE context, allocated IP addresses for UE 501, and network address for P-CSCF 541. AMF 521 transfers the registration accept message to UE 501 over the NAS link that traverses RAN 511.

UE 501 receives the registration accept message and utilizes the UE context to begin one or more PDU sessions over 5G network core 520. UE 501 initiates an IMS registration request to register with IMS core 540. UE 501 generates a SIP IMS registration request and uses the network address for P-CSCF 541 in the UE context to transfer the SIP registration request to UPF 523 over RAN 511. UPF 523 forwards the SIP IMS registration request to P-CSCF 541 based on the network address for P-CSCF 541 included in the request. P-CSCF 541 receives the registration request from UPF 523. P-CSCF 541 retrieves a network address for I-CSCF 542 (e.g., by Domain Name Service (DNS) query) and forwards the registration request to I-CSCF 542 using the retrieved network address. I-CSCF 542 generates a User Authorization Request (UAR) to identify available S-CSCFs and transfers the UAR for to UDM 525. UDM 525 determines a set of available S-CSCFs, including S-CSCF 543, and transfers a User Authorization Answer (UAA) indicating the available S-CSCFs. I-CSCF 542 receives the UAA and selects S-CSCF 543 to register UE 501. I-CSCF 542 forwards the registration request with the network address to S-CSCF 543.

S-CSCF 543 receives the registration request and generates a Multimedia Authentication Request (MAR) to retrieve user authentication data associated with UE 501. S-CSCF 543 transfers the MAR for delivery to UDM 525. UDM 525 receives the MAR and accesses a subscriber profile for UE 501 to retrieve authentication data. The authentication data typically includes a random number, an authentication token, a signed result, a cipher key, and an integrity key. UDM 525 transfers a Multimedia Authorization Answer (MAA) that includes the authentication data to S-CSCF 543.

S-CSCF 543 selects authentication vectors to verify the identity of UE 501 based on the authentication data. S-CSCF 543 generates a SIP 401 message that comprises the authentication data and transfers the SIP 401 message to I-CSCF 542 which in turn forwards the SIP 401 message to P-CSCF 541. P-CSCF 541 removes and caches a portion of the authentication data from the SIP 401 message. P-CSFC 631 transfers the SIP 401 message to UPF 523 for delivery to UE 501. The remaining authentication data in the SIP 401 message comprises a random number and authentication token that UE 501 can use to generate an authentication response to verify its identity. UPF 523 transfers the SIP 401 message to UE 501 over RAN 511. UE 501 uses the random number and authentication token received in the SIP 401 message to generate an authentication response. UE 501 and P-CSCF 541 exchange signaling to set up a secure signaling channel using the authentication data cached by P-CSCF 541.

UE 501 generates a second SIP IMS registration request to complete the registration with IMS core 540. The second SIP IMS registration request includes the authentication response generated by UE 501 in the SIP message header. UE 501 addresses the second SIP registration request for P-CSCF 541 and transfers the second SIP registration request to UPF 523. UPF 523 identifies the network address in the second SIP registration request and forwards the request to P-CSCF 541. P-CSCF 541 receives the second registration request from UPF 523 and forwards the request to I-CSCF 542. I-CSCF 542 generates a second UAR and transfers the second UAR to UDM 525. UDM 525 receives the second UAR and determines a set of available S-CSCFs and transfers a second UAA indicating the S-CSCFs to I-CSCF 542. I-CSCF 542 receives the UAA and selects S-CSCF 543. I-CSCF 542 forwards the second registration request with the authentication response to S-CSCF 543.

S-CSCF 543 receives the second SIP IMS registration request and reads the message header to determine the authentication response generated by UE 501. S-CSCF 543 generates a Server Assignment Request (SAR) to retrieve subscriber data associated with UE 501 to verify the authentication response generated by UE 501. S-CSCF 543 transfers the SAR for delivery to UDM 525. UDM 525 receives the SAR and accesses the subscriber profile for UE 501 to retrieve the subscriber data. UDM 525 transfers a Server Assignment Answer (SAA) that includes the subscriber data to S-CSCF 543. S-CSCF 543 matches an expected result for the authentication challenge to the authentication response from UE 501 to authenticate the identity of UE 501. S-CSCF 543 registers UE 501 for IMS service based on the authentication. S-CSCF 543 generates a SIP 200 message to acknowledge the registration. S-CSCF 543 transfers the SIP 200 message to I-CSCF 542 which in turn forwards the SIP 200 message to P-CSCF 541. P-CSFC 541 transfers the SIP 200 message to UPF 523 for delivery to UE 501. UPF 523 transfers the SIP 200 message to UE 501 over RAN 511.

Once registered, UE 501 displays a prompt that allows the user to select emergency contacts. UE 501 receives a user input that selects UE 502 as the emergency contact for UE 501. Although UE 501 selects a single emergency contact in this example, in other examples UE 501 may select multiple emergency contacts. UE 501 transfers a SIP message that includes an emergency contact list to P-CSCF 541 over RAN 511 and UPF 523. The emergency contact list identifies UE 502 by IMSI. P-CSCF 541 routes the emergency contact SIP message to S-CSCF 543. S-CSCF 543 queries UDM 525 with the IMSI of UE 502 to determine the network location of UE 502. UDM 525 notifies S-CSCF 543 that UE 502 is in network location B and registered with IMS core 540 on S-CSCF 553. In response, S-CSCF 543 transfers a SIP emergency contact request for UE 502 to S-CSCF 553. S-CSCF 553 routes the SIP emergency contact request to UE 502 over P-CSCF 551, UPF 533, and RAN 512. The SIP emergency contact request requests that UE 502 become an emergency contact of UE 501. UE 502 displays a prompt indicating the request and receives a user input approving the request. UE 502 transfers a SIP emergency contact response indicating the approval to S-CSCF 553 over RAN 512, UPF 533, and P-CSCF 551. S-CSCF 553 forwards the SIP emergency contact response to S-CSCF 543. S-CSCF 543 transfers the SIP emergency contact response to P-CSCF 541 and directs P-CSCF 541 to create a contact binding that identifies UE 502 by IMSI as an emergency contact of UE 501, that pre-approves emergency voice calls from UE 501 to UE 502, and that indicates the network location of UE 502. P-CSCF 541 creates the contact binding and delivers the SIP emergency contact response to UE 501 over UPF 523, and RAN 511. UE 501 displays a notification for the user indicating the successful emergency contact creation.

P-CSCF 541 periodically pings UDM 525 to maintain an up-to-date network location of UE 502 stored in the contact binding. For example, P-CSCF 541 may transfer a location update request to UDM 525 for the network location (e.g., the P-CSCF in IMS core 540 where UE 501 is registered) of UE 502. When the network location of UE 502 changes, UDM 525 provides the updated network location to P-CSCF 541. P-CSCF 541 updates the contact binding to remove the stale network location and include the updated network location of UE 502. In other examples, P-CSCF 541 may ping UDM 525 to maintain an up-to-date network location of UE 502 over some other time scale (e.g., semi-periodically, continuously, randomly, etc.).

In other examples, the user of UE 502 may reject the emergency contact request from UE 501. In this case, UE 502 transfers a SIP emergency contact response to S-CSCF 553 indicating the rejection. S-CSCF 553 forwards the response to S-CSCF 543. S-CSCF 543 transfers the SIP emergency contact response to UE 501 over P-CSCF 541, UPF 523, and RAN 511. P-CSCF 541 forgoes creation of the contact binding. UE 501 displays a notification for the user that indicates the rejection of the emergency contact creation.

Returning to the operation, an emergency occurs affecting the user of UE 501 subsequent to the creation of the contact binding between UE 501 and UE 502. In response, UE 501 initiates an emergency Mobile Originated (MO) IMS voice session with UE 502 over IMS core 540. UE 501 generates a quick-connect SIP invite message and addresses the message for delivery to P-CSCF 541. The message header of the quick-connect SIP invite classifies the call as an emergency and indicates the voice call is for UE 502. UE 501 transfers the SIP invite to UPF 523 which forwards the SIP quick-connect invite message to P-CSCF 541. In conventional IMS call setup, the P-CSCF interfaces with the I-CSCF, S-CSCF, and TAS to set up the voice call and the participating UEs undergo a signaling intensive handshake process to begin the call. The interfacing between the IMS functions and the signaling intensive handshake process increase the time it takes to set up the voice call which negatively affects the user experience during emergency or other urgent situations.

P-CSCF 541 receives the quick-connect SIP invite and reads the message header to determine the invite is for an emergency call with UE 502. In response, P-CSCF 541 accesses the contact binding for UE 501 to confirm UE 502 is an emergency contact of UE 501 and determine the network location of UE 502. In response, P-CSCF 541 approves the emergency call and forgoes conventional IMS call setup between UEs 501 and 502 based on the contact binding. P-CSCF 541 forwards the quick-connect SIP invite to P-CSCF 551 based on the network location of UE 502 stored in the contact binding. P-CSCF 551 delivers the quick-connect SIP invite to UE 502 over UPF 533 and RAN 512.

Contemporaneously, P-CSCF 541 establishes a push-to-talk link between UE 501 and UE 502 based on the IMS session pre-approval in the contact binding. The push-to-talk link traverses RAN 511, UPF 523, BGW 544, BGW 554, UPF 533, and RAN 512. P-CSCF 541 may notify UE 501 that the push-to-talk link is ready. UE 501 generates push-to-talk voice data and transfers the push-to-talk voice data to UE 502 over the push-to-talk link that traverses RAN 511, UPF 523, BGW 544, BGW 554, UPF 533, and RAN 512. UE 502 receives and plays the push-to-talk data for the user of UE 502. TAS 545 and/or TAS 555 support the push-to-talk session between UEs 501 and 502.

UE 502 receives and the quick-connect SIP invite. The user of UE 502 accepts the invite and UE 502 transfers a SIP response to P-CSCF 551 which in turn forwards the response to P-CSCF 541. P-CSCF 541 delivers the SIP response indicating the call acceptance to UE 501. P-CSCF 541 establishes a VoNR call link that traverses RAN 511, UPF 523, BGW 544, BGW 554, UPF 533, and RAN 512. UE 501 and UE 502 generate VoNR call data. UE 501 exchanges the VoNR data with UPF 523 over RAN 511. UPF 523 exchanges the VoNR data with UPF 533 over BGWs 544 and 554. UPF 523 exchanges the VoNR data with UE 502 over RAN 512. UEs 501 and 502 play the VoNR call data for their respective users. TAS 545 and/or TAS 555 support the VoNR session between UEs 501 and 502.

In some examples, network 500 may support quick-connect LTE calls (e.g., VOLTE calls) between UE 501 and UE 502. Network 500 operates similarly when in an LTE mode, however network entities in core 520 like MME, HSS, HLR, PCRF, P-GW, and S-GW handle EPC registration and VOLTE call data exchange. For example, MME operates analogously to AMF 521, P-GW and S-GW operate analogously to SMF 522 and UPF 523, PCRF operates analogously to PCF 524, and HSS/HLR operate analogously to UDR 525.

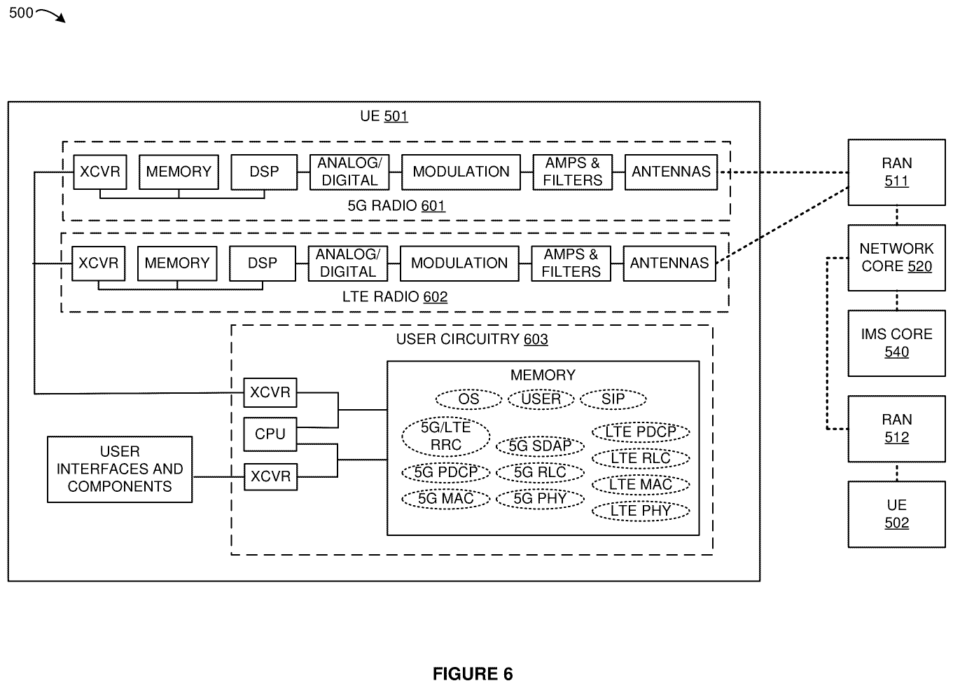

FIG. 6 illustrates UE 501 in 5G communication network 500. UE 501 comprises an example of user devices 101 and 151 illustrated in FIG. 1, although user devices 101 and 151 may differ. UE 501 comprises 5G radio 601, LTE radio 602, and user circuitry 603. UE 502 comprises a similar or the same architecture as UE 501. Although UE 501 is illustrated as 5GNR and LTE device, in some examples UE 501 may lack 5GNR or LTE capability. When UE 501 is a 5GNR device that lacks LTE capabilities, LTE radio 602 and the LTE network applications are omitted. When UE 501 is an LTE device that lacks 5GNR capabilities, 5GNR radio 601 and the 5GNR network applications are omitted.

5G Radio 601 comprises 5GNR antennas, amplifiers, filters, modulation, analog-to-digital interfaces, Digital Signal Processers (DSP), memory, and transceivers (XCVRs) that are coupled over bus circuitry. LTE radio 602 comprises LTE antennas, amplifiers, filters, modulation, analog-to-digital interfaces, Digital Signal Processers (DSP), memory, and transceivers (XCVRs) that are coupled over bus circuitry. User circuitry 603 comprises memory, CPU, user interfaces and components, and transceivers that are coupled over bus circuitry.

The memory in user circuitry 603 stores an operating system (OS), user applications, Session Initiation Protocol (SIP) applications, 5GNR network applications for PHY, MAC, RLC, PDCP, SDAP, and RRC, and LTE network applications for RRC, PDCP, RLC, MAC, and PHY. The antenna in 5G radio 601 is wirelessly coupled to RAN 511 over a 5GNR link. The antenna in LTE radio 602 is wirelessly coupled to RAN 511 over an LTE link. Transceivers in radios 601 and 602 are coupled to a transceiver in user circuitry 603. A transceiver in user circuitry 603 is typically coupled to the user interfaces and components like displays, controllers, and memory.

In 5G radio 601, the antennas receive wireless signals from RAN 511 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 603 over the transceivers. In user circuitry 603, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to RAN 511 that transport the uplink 5GNR signaling and data.

In LTE radio 602, the antennas receive wireless signals from RAN 511 that transport downlink LTE signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding LTE symbols to user circuitry 603 over the transceivers. In user circuitry 603, the CPU executes the network applications to process the LTE symbols and recover the downlink LTE signaling and data. The LTE network applications receive new uplink signaling and data from the user applications. The network applications process the uplink user signaling and the downlink LTE signaling to generate new downlink user signaling and new uplink LTE signaling. The network applications transfer the new downlink user signaling and data to the user applications. The LTE network applications process the new uplink LTE signaling and user data to generate corresponding uplink LTE symbols that carry the uplink LTE signaling and data.

In LTE radio 602, the DSP processes the uplink LTE symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless LTE signals to RAN 511 that transport the uplink LTE signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). SIP application capabilities comprise SIP message generation and quick-connect SIP invite generation.

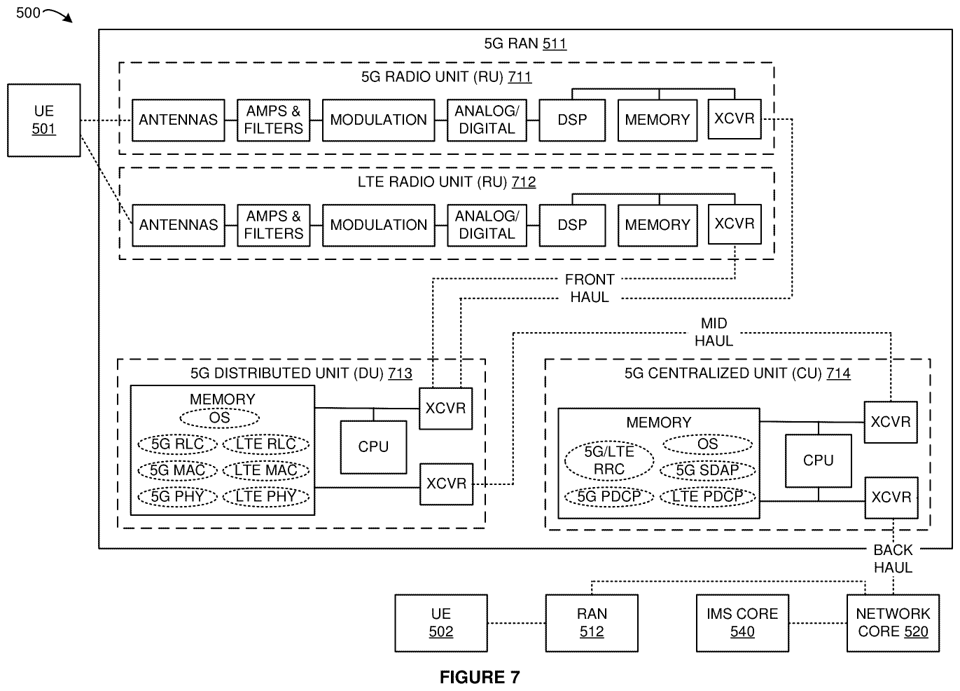

FIG. 7 illustrates RAN 511 in 5G communication network 500. RAN 511 comprises an example of the access networks 111 and 141 illustrated in FIG. 1, although access networks 111 and 141 may differ. RAN 512 comprises a similar or the same architecture as RAN 511. RAN 511 comprises 5G RU 711, LTE RU 712, DU 713, and CU 714. RU 711 comprises 5GNR antennas, amplifiers, filters, modulation, analog-to-digital interfaces, DSP, memory, and transceivers (XCVRs) that are coupled over bus circuitry. LTE RU 712 comprises LTE antennas, amplifiers, filters, modulation, analog-to-digital interfaces, DSP, memory, and transceivers (XCVRs) that are coupled over bus circuitry. UE 501 is wirelessly coupled to antennas in 5G RU 711 over 5GNR links and to antennas in LTE RU 712 over LTE links. Transceivers in 5G RU 711 and LTE RU 712 are coupled to transceivers in DU 713 over fronthaul links like enhanced Common Public Radio Interface (eCPRI). The DSPs in RU 711 executes their operating systems and radio applications to exchange 5GNR signals with UE 501 and to exchange 5GNR data with DU 713. The DSPs in RU 712 execute their operating systems and radio applications to exchange LTE signals with UE 501 and to exchange LTE data with DU 713.

For the uplink, the antennas in RUs 711 and 712 receive wireless signals from UE 501 that transport uplink 5GNR/LTE signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR/LTE symbols to DU 713 over the transceivers.

For the downlink, the DSPs receive downlink 5GNR/LTE symbols from DU 713. The DSPs process the downlink 5GNR/LTE symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR/LTE signaling and data.

DU 713 comprises memory, CPU, and transceivers that are coupled over bus circuitry. The memory in DU 713 stores operating systems, 5GNR network applications like PHY, MAC, and RLC, and LTE network applications like PHY, MAC, and RLC. CU 714 comprises memory, CPU, and transceivers that are coupled over bus circuitry. The memory in CU 714 stores an operating system, 5GNR network applications like PDCP, SDAP, and RRC, and LTE network applications like PDCP and RRC. Transceivers in DU 713 are coupled to transceivers in RUs 711 and 712 over front-haul links. Transceivers in DU 713 are coupled to transceivers in CU 714 over mid-haul links. A transceiver in CU 714 is coupled to network core 520 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

While illustrated as comprising an LTE/5GNR RAN, in some examples RAN 511 may comprise a 5GNR RAN or an LTE RAN. When RAN 511 comprises a 5GRN RAN, LTE RU 702 and the LTE network applications stored in DU 713 and CU 714 are omitted. When RAN 511 comprises an LTE RAN, 5G RU 701 and the 5GNR network applications stored in DU 713 and CU 714 are omitted. Additionally, when RAN 511 comprises an LTE RAN, DU 713 and CU 714 are typically merged into a BBU.

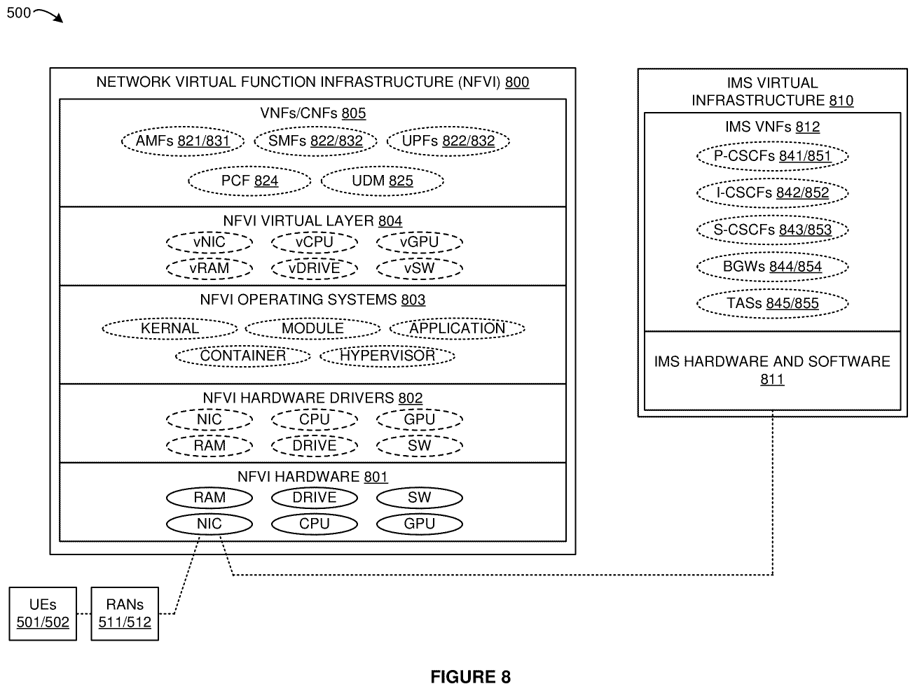

FIG. 8 illustrates Network Function Virtualization Infrastructure (NFVI) 800 and IMS virtual infrastructure 810 in 5G wireless communication network 500. NFVI 800 comprises an example of core network 121 illustrated in FIG. 1, although core network 121 may differ. NFVI 800 comprises NFVI hardware 801, NFVI hardware drivers 802, NFVI operating systems 803, NFVI virtual layer 804, and NFVI Virtual Network Functions (VNFs)/Cloud-Native Network Functions (CNFs) 805. NFVI hardware 801 comprises Network Interface Cards (NICs), CPU, GPU, RAM, Flash/Disk Drives (DRIVE), and Data Switches (SW). NFVI hardware drivers 802 comprise software that is resident in the NIC, CPU, GPU, RAM, DRIVE, and SW. NFVI operating systems 803 comprise kernels, modules, applications, containers, hypervisors, and the like. NFVI virtual layer 804 comprises vNIC, vCPU, vGPU, vRAM, vDRIVE, and vSW. NFVI VNFs/CNFs 805 comprise AMFs 821/831, SMFs 822/832, UPFs 823/833, PCF 824, and UDM 825. Additional VNFs and network elements like AUSF, NSSF, UDR, HLR, HSS, NRF, SMSF, NEF, AF, EIR, SCP, MME, S-GW, P-GW, and PCRF are typically present but are omitted for clarity.

IMS virtual infrastructure 810 comprises an example of multimedia system 130 illustrated in FIG. 1, although multimedia system 130 may differ. IMS virtual infrastructure 810 comprises IMS hardware and software 811 and IMS VNFs 812. IMS hardware and software 811 comprises NICs, CPU, GPU, RAM, DRIVE, and SW and hardware drivers resident in the NIC, CPU, GPU, RAM, DRIVE, and SW. IMS hardware and software 811 comprises operating systems like kernels, modules, applications, containers, and hypervisors as well as a virtual layer that comprises vNIC, vCPU, vGPU, vRAM, vDRIVE, and vSW. IMS VNFs comprise P-CSCFs 841/851, I-CSCFs 842/852, S-CSCFs 843/853, BGWs 844/854, and TASs 845/855. Additional IMS VNFs and network elements like ISBC, SMS AS, and RCS AS are typically present but are omitted for clarity.

NFVI 800 and IMS virtual infrastructure 810 may be co-located, each located at a single site, or be distributed across multiple geographic locations. The NIC in NFVI hardware 801 is coupled to RANs 511 and 512, the NIC in IMS hardware and software 811, and to external systems (not illustrated). The NIC in IMS hardware and software 811 is coupled to the NIC in NFVI hardware 801 and to external systems. NFVI hardware 801 executes NFVI hardware drivers 802, NFVI operating systems 803, NFVI virtual layer 804, and NFVI VNFs/CNFs 805 to form AMFs 521/531, SMFs 522/532, UPFs 523/533, PCF 524, and UDM 525. The hardware in IMS hardware and software and software 811 executes the hardware drivers, operating systems, virtual layer, and IMS VNFs 812 to form P-CSCFs 541/551, I-CSCFs 542/552, S-CSCFs 543/553, BGWs 544/554, and TASs 545/555.

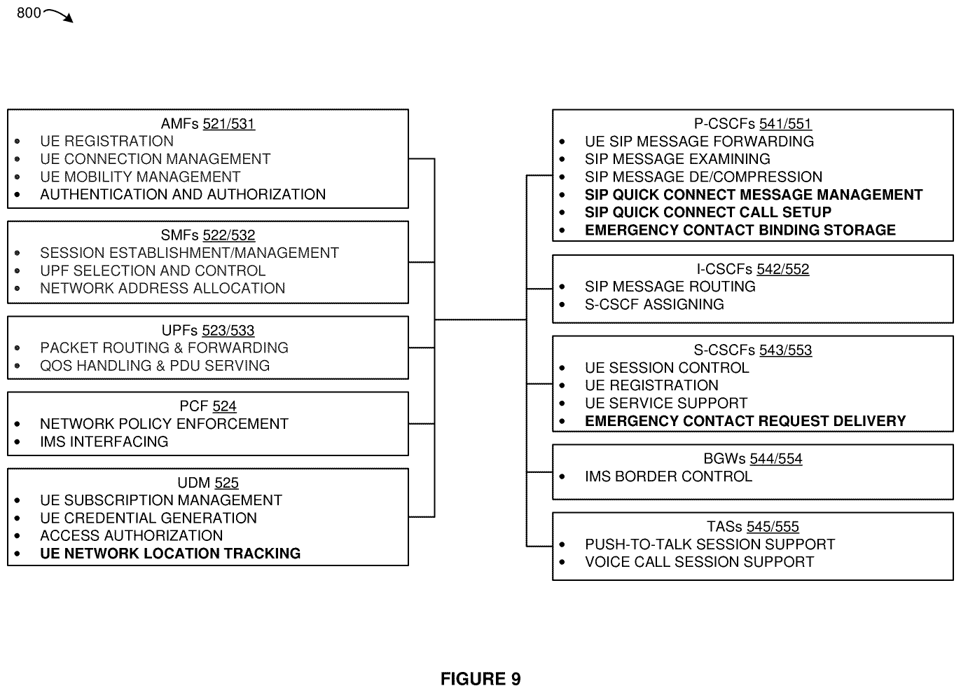

FIG. 9 further illustrates NFVI 800 and IMS virtual infrastructure 810 in 5G communication network 500. AMFs 521/531 comprise capabilities for UE registration, UE connection management, UE mobility management, authentication, and authorization. SMFs 522/532 comprise capabilities for session establishment, session management, UPF selection, UPF control, and network address allocation. UPFs 523/533 comprise capabilities for packet routing, packet forwarding, QoS handling, and PDU serving. PCF 524 comprises capabilities for network policy enforcement and IMS interfacing. UDM 525 comprises capabilities for UE subscription management, UE credential generation, UE access authorization, and UE network location tracking. P-CSCFs 541/551 comprise capabilities for UE SIP message forwarding, SIP message examining, SIP message compression/decompression, SIP quick connect message management, SIP quick connect call setup, and emergency contact binding storage. I-CSCFs 542/552 comprise capabilities for UE session SIP message routing and S-CSCF assigning. S-CSCFs 543/553 comprise capabilities for UE session control, UE registration, UE service support, and emergency contact request delivery. BGWs 544/554 comprise capabilities for IMS border control. TASs 545/555 comprise capabilities for push-to-talk session support and voice call session support.

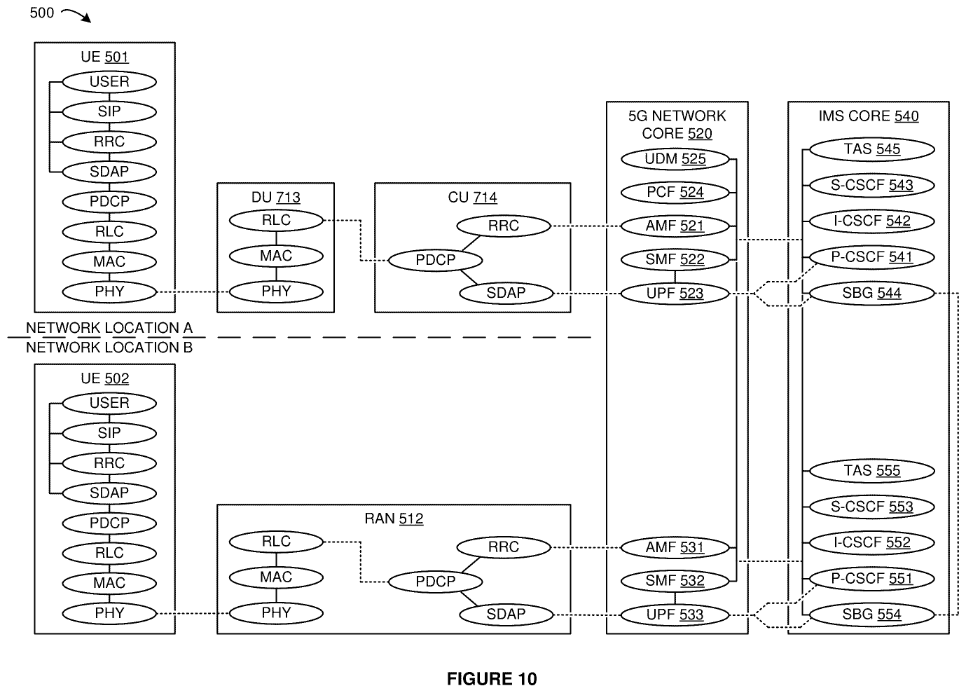

FIG. 10 illustrates an exemplary operation of 5G communication network 500 to support emergency IMS sessions between wireless UEs. In some examples, once registered with IMS core 540, the RRC in UE 501 drives the SIP application to generate a SIP message that includes an emergency contact list identifying UE 502 as an emergency contact. The SDAP in UE 501 transfers the SIP message to the SDAP in CU 714 over the PDCPs, RLCs, MACs, and PHYs. The SDAP in CU 714 forwards the SIP message to P-CSCF 541 over UPF 523. P-CSCF 541 delivers the SIP message to S-CSCF 543 which interfaces with UDM 525 to determine where UE 502 is registered on IMS core 540. UDM 525 indicates UE 502 registered with IMS core 540 on S-CSCF 553. In response, S-CSCF 543 generates and transfers a SIP emergency contact request for UE 502 to S-CSCF 553. S-CSCF 553 drives P-CSCF 551 to route the SIP emergency contact request to the SDAP in RAN 512 over P-CSCF 551 and UPF 533.

The SDAP in RAN 512 transfers the contact request to the SDAP in UE 502 over the PDCPs, RLCs, MACs, and PHYs. UE 502 accepts the request and the SDAP transfers a SIP emergency contact response indicating the approval to the SDAP in RAN 512 over the PDCPs, RLCs, MACs, and PHYs. The SDAP transfers the response to S-CSCF 553 over UPF 533 and P-CSCF 551. S-CSCF 553 forwards the response to S-CSCF 543. S-CSCF 543 transfers the SIP emergency contact response to P-CSCF 541 and directs P-CSCF 541 to create a contact binding that identifies UE 502 as an emergency contact of UE 501, that pre-approves emergency voice calls from UE 501 to UE 502, and that indicates the network location of UE 502. P-CSCF 541 creates the contact binding and delivers the SIP emergency contact response to the SDAP in CU 714 over UPF 523. The SDAP in CU 714 transfers the response to the SDAP in UE 501 over the PDCPs, RLCs, MACs, and PHYs.

The RRC in UE 501 receives a user input requesting an emergency call with UE 502. In response, the RRC directs the SIP application to generate a quick-connect SIP invite. The SIP application generates the quick-connect SIP invite. The SDAP transfers the invite to the SDAP in CU 714 over the PDCPs, RLCs, MACs, and PHYs. The SDAP in CU 714 routes the SIP invite to P-CSCF 541 over UPF 523. P-CSCF 541 reads the message header of the SIP invite to determine the invite is for an emergency call with UE 502. In response, P-CSCF 541 accesses the contact binding for UE 501 to confirm UE 502 is an emergency contact of UE 501 and determine the network location of UE 502. In response, P-CSCF 541 approves the emergency call and forwards the quick-connect SIP invite to P-CSCF 551 based on the network location of UE 502 stored in the contact binding. P-CSCF 551 transfers the quick-connect SIP invite to the SDAP in RAN 512 over UPF 533. The SDAP in RAN 512 forwards the SIP invite to the SDAP in UE 502 over the PDCPs, RLCs, MACs, and PHYs.

P-CSCF 541 interfaces with UPFs 523 and 533 and with BGWs 544 and 554 to organize a push-to-talk link between UE 501 and UE 502 based on the IMS session pre-approval in the contact binding. UE 501 receives voice inputs and generates push-to-talk voice data based on the voice inputs. The SDAP in UE 501 transfers the push-to-talk voice data to the SDAP in CU 714 over the PDCPs, RLCs, MACs, and PHYs. The SDAP transfers the push-to-talk voice data to UPF 523. UPF 523 transfers the push-to-talk voice data to UPF 533 over BGWs 544 and 554. UPF 533 transfers the push-to-talk voice data to the SDAP in RAN 512. The SDAP in RAN 512 delivers the push-to-talk voice data to the SDAP in UE 502 over the PDCPs, RLCs, MACs, and PHYs. UE 502 receives and plays the push-to-talk voice data for the user. TAS 545 and/or TAS 555 support the push-to-talk session between UEs 501 and 502.

UE 502 receives the quick-connect SIP invite. The RRC in UE 502 receives a user input accepting the emergency call with UE 501. In response, the RRC directs the SIP application to generate a quick-connect SIP response. The SIP application generates the quick-connect SIP response. The SDAP in UE 502 transfers the response to the SDAP in RAN 512 over the PDCPs, RLCs, MACs, and PHYs. The SDAP in RAN 512 transfers the response to P-CSCF 551 over UPF 533 which in turn forwards the response to P-CSCF 541. P-CSCF 541 delivers the SIP response indicating the call acceptance to the SDAP in CU 714 over UPF 523. The SDAP in CU 714 transfers the quick-connect SIP response to the SDAP in UE 501 over the PDCPs, RLCs, MACs, and PHYs. P-CSCF 541 establishes a VoNR call link that traverses RAN 511, UPF 523, BGW 544, BGW 554, UPF 533, and RAN 512. UE 501 and UE 502 receive voice inputs and generate VoNR call data. The SDAP in UE 501 exchanges the VoNR data with the SDAP in CU 714 over the PDCPs, RLCs, MACs, and PHYs. The SDAP in CU 714 exchanges the VoNR voice data with UPF 523. UPF 523 exchanges the VoNR data with UPF 533 over BGWs 544 and 554. UPF 523 exchanges the VoNR data with the SDAP in RAN 512. The SDAP in RAN 512 exchanges the VoNR data with the SDAP in UE 502 over the PDCPs, RLCs, MACs, and PHYs. UEs 501 and 502 play the VoNR call data for their respective users. TAS 545 and/or TAS 555 support the VoNR session between UEs 501 and 502.

The wireless data network circuitry described above comprises computer hardware and software that form special-purpose network circuitry to support emergency multimedia sessions between wireless user devices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to support emergency multimedia sessions between wireless user devices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
receiving, by a multimedia controller in a communication network, an emergency contact list from the user device that identifies another user device;
transferring, by the multimedia controller, an emergency contact request to the other user device and receiving an emergency contact accept response from the other user device; and
creating, by the multimedia controller, a contact binding that pre-approves multimedia sessions between the user device and the other user device.

2. The method of claim 1, wherein the contact binding indicates a network location, further comprising:
receiving, by the multimedia controller, an emergency call request from the user device to establish an emergency multimedia session with the other user device;
forwarding, by the multimedia controller, the emergency call request to the other user device based on the network location of the other user device; and
establishing, by the multimedia controller, a one-way multimedia session between the user device and the other user device based on the multimedia session pre-approval.

3. The method of claim 2 further comprising establishing, by the multimedia controller, a two-way multimedia session based on the multimedia session pre-approval in response to the other user device accepting the emergency call request.

4. The method of claim 2 further comprising querying, by the multimedia function, a data system in the communication network to determine the network location of the other wireless user device.

5. The method of claim 2 further comprising querying, by the multimedia function, a data system in the communication network to determine a new network location of the other wireless user device and updating the contact binding with the new network location of the other wireless user device.

6. The method of claim 2 wherein:
receiving, by the multimedia controller, the emergency contact list from the user device that identifies the other user device comprises, receiving, by the multimedia controller and responsive to multimedia service registration for the user device, the emergency contact list that comprises an International Mobile Subscriber Identity (IMSI) that identifies the other user device; and
the other user device receives the emergency contact request, approves the emergency contact request, and transfers the emergency contact accept response for delivery to the multimedia controller.

7. The method of claim 2 wherein:
receiving, by the multimedia controller, the emergency call request from the user device to establish the emergency multimedia session with the other user device comprises receiving, by the multimedia controller, a Session Initiation Protocol (SIP) call invite to establish the emergency multimedia session with the other user device; and
forwarding, by the multimedia controller, the emergency call request to the other user device based on the network location of the other user device comprises forwarding, by the multimedia controller, the SIP invite to the other user device based on the network location of the other user device.

8. The method of claim 2 wherein establishing, by the multimedia controller, the one-way multimedia session between the user device and the other user device based on the multimedia session pre-approval comprises establishing, by the multimedia controller, a push-to-talk session between the user device and the other user device based on the multimedia session pre-approval.

9. The method of claim 2 wherein establishing, by the multimedia controller, the two-way multimedia session based on the multimedia session pre-approval in response to the other user device accepting the emergency call request comprises establishing, by the multimedia controller, at least one of a Voice Over New Radio (VoNR) call or a Voice Over Long Term Evolution (VOLTE) call based on the multimedia session pre-approval in response to the other user device accepting the emergency call request.

10. The method of claim 2 wherein the multimedia controller comprises one or more of a Proxy Call Session Control Function (P-CSCF), an Interrogating Call Session Control Function (I-CSCF), or a Serving Call Session Control Function (S-CSCF).

11. A communication network comprising:
a multimedia controller configured to:
responsive to multimedia service registration for a user device, receive an emergency contact list from the user device that identifies another user device;
transfer an emergency contact request to the other user device and receive an emergency contact accept response from the other user device, wherein the other user device receives the emergency contact request, approves the emergency contact request, and transfers the emergency contact accept response for delivery to the multimedia controller;
create a contact binding that pre-approves multimedia sessions between the user device and the other user device and that indicates a network location of the other user device;
receive an emergency call request from the user device to establish an emergency multimedia session with the other user device;
forward the emergency call request to the other user device based on the network location of the other user device; and
establish a one-way multimedia session between the user device and the other user device based on the multimedia session pre-approval.

12. The communication network of claim 11 wherein the multimedia controller is further configured to establish a two-way multimedia session in response to the other user device accepting the emergency call request based on the multimedia session pre-approval.

13. The communication network of claim 11 wherein the multimedia controller is further configured to query a data system in the communication network to determine the network location of the other wireless user device.

14. The communication network of claim 11 wherein the multimedia controller is further configured to query a data system in the communication network to determine a new network location of the other wireless user device and update the contact binding with the new network location of the other wireless user device.

15. The communication network of claim 11 wherein the multimedia controller is configured to receive the emergency contact list that comprises an International Mobile Subscriber Identity (IMSI) that identifies the other user device.

16. The communication network of claim 11 wherein the emergency call request comprises a Session Initiation Protocol (SIP) call invite.

17. The communication network of claim 11 wherein the one-way voice call comprises a push-to-talk session.

18. The communication network of claim 11 wherein the two-way voice call comprises at least one of a Voice Over New Radio (VoNR) call or a Voice Over Long Term Evolution (VOLTE) call.

19. The communication network of claim 11 wherein the multimedia controller comprises one or more of a Proxy Call Session Control Function (P-CSCF), an Interrogating Call Session Control Function (I-CSCF), or a Serving Call Session Control Function (S-CSCF).

20. One of more non-transitory computer readable storage media having program instructions stored thereon, wherein the program instruction, when executed by a computing system, direct the computing system to perform operations, the operations comprising:
creating a contact binding that pre-approves emergency multimedia sessions between a user device and another user device and that indicates a location of the other user device;
receiving an emergency call invite from the user device to establish an emergency multimedia session with the other user device;
forwarding the emergency call invite to the other user device based on the contact binding;
delivering a push-to-talk voice message from the user device to the other user device based on the contact binding; and
establishing a voice call between the user device and the other user device in response to the other user device accepting the emergency call invite.
